(19) United States
(12) Patent Application Publication
(10) Pub. No.: US 2025/0053648 A1
(43) Pub. Date: Feb. 13, 2025

(54) METHOD FOR TRAINING AN AUTONOMOUS AGENT USING A REINFORCEMENT LEARNING ALGORITHM, ASSOCIATED AUTONOMOUS AGENT

(71) Applicant: Orange, Issy-Les-Moulineaux (FR)

(72) Inventors: Tony QUERTIER, Chatillion (FR); Benjamin MARAIS, Chatillion (FR); Bertrand FOURNEL, Chatillion (FR)

(21) Appl. No.: 18/720,203

(22) PCT Filed: Dec. 8, 2022
(86) PCT No.: PCT/EP2022/085003

§ 371 Date: Jun. 14, 2024

(30) Foreign Application Priority Data
Dec. 15, 2021 (FR) FR2113534

(51) Int. Cl. G06F 21/55; G06F 21/56

(52) U.S. Cl. CPC G06F 21/554; G06F 21/565

(57) ABSTRACT

A method for training an autonomous agent implementing a reinforcement learning algorithm to improve the performance of anti-malware software. The method includes: selecting an action aimed at modifying the content of a malware; transmitting the selected action to an environment implementing said anti-malware software; receiving, from the environment, a reward representing a probability that the malware modified by application of the selected action is considered benign by the anti-malware software; obtaining a state representative of the malware modified by application of the selected action; the steps of selecting an action, receiving a reward and obtaining a state being iterated as long as a stopping criterion is not reached; and, determining, by the reinforcement learning algorithm and based on the obtained rewards, a function which associates with each state at least one action to be executed, so as to maximize a sum of the obtained rewards.

### CROSS-REFERENCE TO RELATED APPLICATIONS

This application is a Section 371 National Stage Application of International Application No. PCT/EP2022/085003, filed Dec. 8, 2022, and published as WO on 2023/110625, not in English, the contents of which are incorporated herein by reference in their entireties.

### FILED OF THE DISCLOSURE

The present invention belongs to the general field of computer security. It more particularly relates to a method for training an autonomous agent implementing a reinforcement learning algorithm to improve the performance of anti-malware software. It also relates to an autonomous agent configured to implement such a method, a method for evaluating the detectability of a malware by an environment implementing anti-malware software, an environment configured to implement such a method, and a method for training anti-malware software implementing a learning algorithm.

### BACKGROUND OF THE DISCLOSURE

A rapid and accurate detection of attacks such as for example an intrusion or a malicious manipulation, or of threats of attacks, in computer equipment or more generally in a computer system is a critical issue for the security of the equipment of this system. The extent of this issue continues to grow today as the volume of traffic generated in the communication networks tends to increase.

Conventionally, this issue is addressed by anti-malware software which are, currently, essentially antivirus software, anti-spyware software, firewalls or virus detection software using machine learning mechanisms.

These anti-malware software, also called anti-malwares, are configured to analyze data present on computer equipment to be protected (such as a server or a personal computer), or data intended to access this equipment with the aim of infecting it. These data, called “malwares”, are developed with the aim of damaging the equipment, without the consent of a user or an administrator of this computer equipment. They include viruses, worms, Trojan horses and malicious computer documents (or maldocs).

Conventionally, the analysis carried out by these anti-malwares is essentially based on static detection rules prohibiting access to the computer equipment, or limiting access by storing these malwares in a secure location, called “quarantine area” so as to completely isolate them from the operating system of the equipment.

More particularly, said analysis is based on a library of signatures specific to one or several known attacks, each signature associated with an attack being characterized by one or several detection rules (for example, a situation in relation to a threshold, a pattern included in a computer code or in a data packet, etc.). Under these conditions, the current anti-malware cannot be considered effective, in terms of protection and defense strategy, against the malwares that are constantly renewed and whose signature is then not known to the anti-malware.

One solution consists in updating these static rules on a regular basis, but such a mechanism leads to a multiplication of the detection rules whose number makes their consistency problematic, and the result is that these current anti-malwares are not always able to detect and a fortiori prohibit or limit access to a malware.

### SUMMARY

The present invention aims to overcome all or part of the drawbacks of the prior art, in particular those set out above, by proposing a solution that allows determining actions aimed at modifying the content of malwares, so that these modified malwares are no longer considered as malicious by an anti-malware.

More particularly, the present invention makes it possible to determine software as being malicious but that is not considered as such by an anti-malware, but also the reasons why these software are not considered malicious. This information turns out to be crucial for the anti-malware authors because it allows them to improve the performance of their solutions in terms of malware detection.

For this purpose, and according to a first aspect, the invention relates to a method for training an autonomous agent implementing a reinforcement learning algorithm to improve the performance of anti-malware software, the method being implemented by the autonomous agent and comprising:
selecting an action aimed at modifying the content of a malware;
transmitting the selected action to an environment implementing said anti-malware software;
receiving, from the environment, a reward (r(t+1)) representative of a probability that the malware modified by application of the selected action (a(t)) is considered benign by the anti-malware software, the reward being defined as:

$$r ( t + 1 ) = \{ \begin{matrix}R ⊂ {R}^{+} if p ( t + 1 ) < T \\ p ( t + 1 ) - p ( t ) otherwise\end{matrix}$$

with R a positive real value, T a threshold value specific to the anti-malware software, p(t+1) a detectability score representative of a probability that the malware modified by application of the selected action (a(t)) is considered malicious by the anti-malware software, and p(t) the detectability score by application of an action selected in the previous iteration;
obtaining (E120, E150) a state (s(t+1)) representative of the malware modified by application of the selected action (a(t));
the steps of selecting an action, receiving a reward and obtaining a state being iterated as long as a stopping criterion is not reached; and,
determining (E130), by the reinforcement learning algorithm and based on the rewards obtained, a function which associates with each state at least one action to be executed, so as to maximize a sum of the obtained rewards.

Thus the training method according to the first aspect relies on a reinforcement learning system comprising an autonomous agent and an environment to determine the best action or sequence of actions to be applied on the content of a malware, so that the latter is now considered by an anti-malware as having a benign behavior.

When software is considered by an anti-malware as having a benign behavior (which can still be called “normal behavior” in the literature), reference is made to the fact that said software is not considered as being likely to be used to carry out a computer attack. It is then understood that the notion of “benign behavior” is defined in contrast to that of malicious behavior.

Another advantageous aspect of the proposed method, in addition to the ability to determine the best action or sequence of actions for an anti-malware to consider a malware as having a benign behavior, lies in the fact that these actions are determined via reinforcement machine learning. In this way, the invention takes advantage of the ability of the agent to discover actions or sequences of actions previously unknown but improving the fact that the malware is considered as having benign behavior, thanks to the artificial intelligence techniques implemented during the learning. It is emphasized here that the malware considered benign retains a malicious behavior. This is then a false negative for the anti-malware software.

Finally, it should also be noted that the fact of implementing reinforcement machine learning allows not having to update static detection rules as is the case for some anti-malwares. Consequently, the proposed method turns out to be inexpensive in terms of expert time.

The method thus makes it possible to create a database grouping together undetectable malwares. This database can then be used to improve anti-malwares, such as anti-viruses, or to train malware detection models using artificial intelligence.

In addition, traces of the action or sequence of actions that allowed modifying a malware into a modified malware considered benign, are kept in order to identify flaws in some anti-malwares.

Generally, it is considered that the steps of a method should not be interpreted as being related to a notion of temporal succession.

In particular modes of implementation, the training method can further include one or several of the following characteristics, taken separately or in all technically possible combinations.

In particular modes of implementation, obtaining a reward comprises receiving, from an environment implementing the anti-malware software, either said reward or a detectability score representative of a probability that the malware modified by application of the selected action is considered malicious by the anti-malware software. And obtaining a state comprises either receiving said state from the environment or obtaining a malware on which an action can be applied, and determining the state based on the selected action and on the obtained malware.

In particular modes of implementation, the reinforcement learning algorithm is a “Q-learning” algorithm, and the determination of the function comprises a determination, for each state-action pair (s,a), of a value Q^{N}(s,a) such that:

$${Q}^{N} ( s , a ) = ( 1 - α ) Q ( s , a ) + α ( r ( t + 1 ) + γ {max}_{a ( t + 1 )} Q ( s ( t + 1 ) , a ( t + 1 ) ) )$$

with α⊂[0,1] a learning rate, Q(s,a) a previous quality value, r(t+1) a reward, γ⊂[0,1] a refresh rate, s(t+1) a next state and a(t+1) an action that can be executed from the state s(t+1), so as to determine an optimal Q-function.

The use of such an algorithm is advantageous in that it is simple to be implemented since the Q-values of each state-action pair are updated by iteration until a Q-function converges towards an optimal Q-function, and since a simple association table (sometimes called “Q-table”) can be used to record the Q-values of all these possible state-action pairs.

In particular modes of implementation, the “Q-learning” algorithm is a deep “Q-learning” algorithm, and the determination of the value Q^{N}(s,a) of each state-action pair (s,a) is implemented by using a deep neural network.

The use of such an algorithm proves particularly advantageous in terms of resource and data management when the cardinal of the set of states S (described below) is significant.

In particular modes of implementation, the selection of an action comprises the application of an Epsilon Greedy strategy.

In particular modes of implementation, the reinforcement learning algorithm is a policy gradient algorithm, and the function determined is a function which, for each state, determines a probability that an action is executed.

In particular modes of implementation, the action is selected from a set of actions comprising:
modifying the value of the field of a header of the malware;
adding to the content of the malware a sequence of characters extracted from a benign file;
adding to the content of the malware determined characters or instructions;
adding to the content of the malware a library extracted from a benign file;
renaming a section of the content of the malware;
removing a debugger mode from the content of the malware;
modifying a timestamp of the content of the malware;
modifying a hash value calculated for an optional header of the content of the malware; and,
decompressing an executable version of the malware.

According to a second aspect, the invention relates to a method for evaluating the detectability of a malware by an environment implementing at least one anti-malware software, the method comprising:
receiving, from an autonomous agent implementing a reinforcement learning algorithm, an action (a(t)) aimed at modifying the content of the malware;
modifying the content of the malware by application of said action (a(t)), so as to obtain a modified malware;
analyzing, by the anti-malware software, the modified malware;
and transmitting, to the autonomous agent, a reward r(t+1)) representative of a probability that the malware modified by application of the selected action (a(t)) is considered benign by the anti-malware software, the reward being defined as:

$$r ( t + 1 ) = \{ \begin{matrix}R ⊂ {R}^{+} & if p ( t + 1 ) < T \\ p ( t + 1 ) - p ( t ) & otherwise\end{matrix}$$

with R a positive real value, T a threshold value specific to the anti-malware software, p(t+1)) a detectability score representative of a probability that the malware modified by application of the selected action (a(t)) is considered malicious by the anti-malware software, and p(t) the detectability score by application of an action selected in the previous iteration.

In particular modes of implementation, the detectability evaluation method further comprises the determination of at least part of the content whose modification does not impact the functionality of the malware; and the modification comprises the modification of said at least one part.

In particular modes of implementation, the detectability evaluation method further comprises the generation of an association between the action (a(t)), and either the score (p(t+1)), or the reward (r(t+1)) in an association table.

In particular modes of implementation, the anti-malware software is an antivirus generating a binary detectability score.

In particular modes of implementation, the malware is compliant with the “portable execution” PE format.

According to a third aspect, the invention relates to a method for training anti-malware software implementing a learning algorithm, the method comprising:
obtaining a plurality of modified malwares in accordance with a method for evaluating the detectability of a malware by an environment implementing at least one anti-malware software according to claim 7, each malware of the plurality having a detectability score (p(t+1)) representative of a probability that the modified malware is considered malicious by the anti-malware software, the score of each malware from the plurality being less than a defined value;
labeling said malwares as malicious; and,
training the anti-malware software with the labeled malwares.

Thus, the invention offers the advantage of making it possible to train an anti-malware implementing a learning algorithm with malwares but which are not considered as such, so as to allow said anti-malware to improve the detection of malicious behaviors.

According to a fourth aspect, the invention relates to a computer program including instructions for the implementation of an autonomous agent training method or an evaluation method or an anti-malware software training method according to the invention, when said program is executed by a processor.

According to a fifth aspect, the invention relates to a computer-readable recording medium on which the computer program according to the invention is recorded.

According to a sixth aspect, the invention relates to an autonomous agent implementing a reinforcement learning algorithm to improve the performance of anti-malware software, the agent also implementing a training method as defined above.

According to a seventh aspect, the invention relates to an environment for evaluating the detectability of a malware by anti-malware software, the environment implementing the evaluation method as defined above.

### BRIEF DESCRIPTION OF THE DRAWINGS

Other characteristics and advantages of the present invention will emerge from the description given below, with reference to the appended drawings which illustrate one exemplary embodiment without any limitation. In the figures:

FIG. 1 is a functional representation of one particular embodiment of a reinforcement learning system as proposed;

FIG. 2 schematically represents one particular embodiment of an autonomous agent as proposed;

FIG. 3 schematically represents one particular embodiment of an environment as proposed;

FIG. 4 schematically represents one example of hardware architecture of a reinforcement learning system of FIG. 1;

FIGS. 5A and 5B schematically represent one example of hardware architecture of a device implementing an autonomous agent belonging to a reinforcement learning system of FIG. 1 (FIG. 5A), and one example of hardware architecture of a device implementing an environment belonging to the reinforcement learning system of FIG. 1 (FIG. 5B);

FIG. 6 represents, in flowchart form, one particular mode of implementation of a general reinforcement learning method as proposed, implemented in a reinforcement learning system comprising the autonomous agent of FIG. 2 and the environment of FIG. 3;

FIG. 7 represents, in flowchart form, one particular mode of implementation of a reinforcement learning method as proposed, implemented in a reinforcement learning system comprising the autonomous agent of FIG. 2 and the environment of FIG. 3; and,

FIG. 8 represents, in flowchart form, one particular mode of implementation of an anti-malware training method implementing a learning algorithm.

### DETAILED DESCRIPTION OF ILLUSTRATIVE EMBODIMENTS

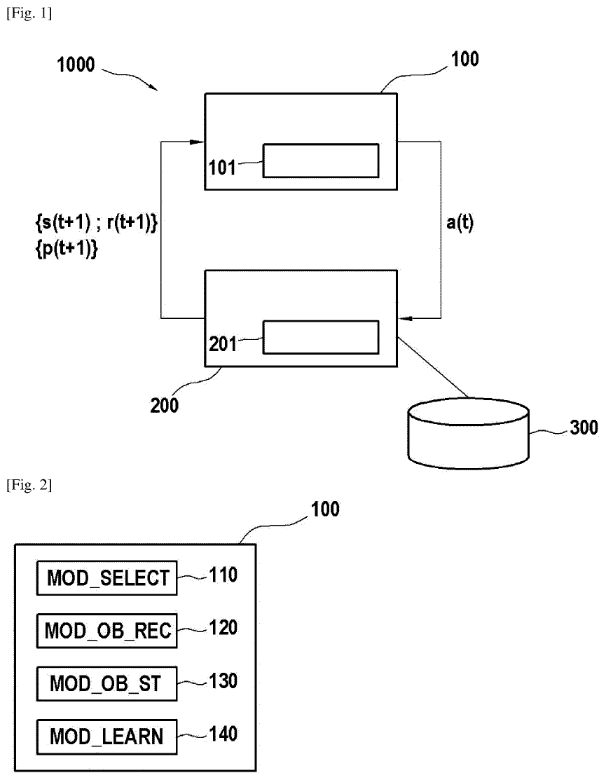

FIG. 1 is a functional representation of one particular embodiment of a reinforcement learning system as proposed.

In the present description, the attacks that can be implemented by a malware are computer type attacks. In a known manner, the notion of computer attack groups any behavior aimed at damaging one or several computer equipment (machines) deployed in a communication network, for example to target a user of a determined equipment, or the communications network itself to alter its functioning.

Also, within the framework of the present invention, no limitation is attached to the attacks that may be envisaged by the malwares. For example, it could be a virus attack (infection); a malicious circumvention of security means such as a firewall; a denial of service attack DoS; etc.

Conventionally, the reinforcement learning consists, for an autonomous agent, in learning the best action or sequence of actions to be carried out from experiments. By autonomous agent, it is meant a software agent, that is to say a computer program that accomplishes tasks like an automaton. More specifically, the autonomous agent observes an environment, and decides on an action or a sequence of actions to be carried out in this environment according to its current state. A state corresponds to a representation of the environment that said agent receives from this environment, for example after an action is carried out on this environment. In return, the environment provides the agent with a reward, which can be a positive reward if the action carried out had a positive impact on the environment, a negative reward which then corresponds to a penalty, or a zero reward. The environment may correspond to a computer representation of a real environment, and in this case the environment also corresponds to a computer program.

These steps of determining an action to be carried out, transitioning to a new current state, and receiving a reward by the agent are repeated as long as a stopping criterion is not reached, and allow the agent to learn or determine an optimal behavior, also called “strategy” or “policy” π, in the sense that it maximizes a gain R(τ) corresponding to a sum of the rewards received over time.

A policy π is a function that matches a given state to actions that can be carried out. The reinforcement learning method then makes it possible to learn the best action or sequence of actions to be carried out when the environment is in a given state.

A reinforcement learning model is formalized as follows: let S be a set of states, A a set of actions, and R a set of rewards. At each iteration, the agent perceives the state s(t)⊂S of the environment and determines, based on this state, an action a(t)⊂A to be carried out. The environment then passes into a new state s(t+1)⊂S and generates a reward r(t+1)⊂R for the action a(t) carried out from the state s(t).

FIG. 1 illustrates a reinforcement learning system 1000 as proposed comprising an autonomous agent 100 and an environment (or platform) 200. The autonomous agent 100 is configured to select an action a(t) aimed at modifying the content of a malware, then transmit, to the environment 200, an instruction to be carried out and comprising the previously selected action a(t).

In response to receiving the action, the environment 200 selects a malware from a set of malwares stored in a malware database 300, and modifies in accordance with said action (a(t)) the content of a selected malware, so as to obtain a modified malware. The environment 200 comprises an anti-malware 201, for example conventional antivirus software or virus detection software using machine learning mechanisms. The modified malware is analyzed by the anti-malware 201, and the environment transmits back, to the autonomous agent 100, a reward r(t+1) representative of a probability that the malware modified by application of the selected action a(t) is considered benign by the anti-malware, as well as a state s(t+1) representative of the modified malware. As a variant, the environment transmits back a detectability score p(t+1)⊂[0,1] representative of a probability that the software is considered malicious.

The agent 100 comprises a reinforcement learning algorithm 101 which uses the information received to determine or update a policy, that is to say a function which associates with each state at least one action to be executed, so as to maximize a sum of the obtained rewards.

According to a first alternative, the reinforcement learning algorithm 101 is a “Q-learning” algorithm. Regarding this aspect, those skilled in the art can refer to the document “Reinforcement Learning, An introduction, Second Edition”, Richard S. Sutton and Andrew G. Barto, The MIT Press, Cambridge, Massachusetts, 2018.

This learning method makes it possible to learn the action to be carried out for each state of the environment, and operates by the learning of a state-action value Q-function which makes it possible to determine the reward Q(s,a) brought by the choice of a certain action a(t) in a certain state s(t) by following an optimal policy π*. When this action-state value Q-function is known after having been learned by the autonomous agent 100, the optimal policy π* can be constructed by selecting the action that has a maximum value for a given state that is to say by selecting the action a(t) that maximizes the value Q(s,a) when the agent is in the state s(t).

Before the learning begins, the Q-function is initialized arbitrarily. Then, at each iteration, the agent observes the reward r(t+1) and the new state s(t+1) that depends on the previous state s(t) and on the action a(t), then updates the value Q-function as follows:

$${Q}^{N} ( s , a ) = ( 1 - α ) Q ( s , a ) + α ( r ( t + 1 ) + γ {max}_{a ( t + 1 )} Q ( s ( t + 1 ) , a ( t + 1 ) ) )$$

with α⊂[0,1] a learning rate, Q(s,a) a previous quality value, r(t+1) a reward, γ⊂[0,1] a refresh rate, s(t+1) a next state and a(t+1) an action that can be executed from the state s(t+1).

The learning rate α is representative of the speed at which the agent abandons the previous value Q(s,a) for the new

$$Q - value r ( t + 1 ) + γ {max}_{a ′} Q ( {s}^{′} , {a}^{′} ) .$$

In other words, the higher the learning rate α, the more quickly the agent will adopt the new Q-value.

Thus, thanks to this learning method, a Q-function which associates with each state an action to be executed is determined.

According to a second alternative, the reinforcement learning algorithm 101 is a deep Q-learning (deep Q-network algorithm (DQN)), and the determination of the value Q^{N}(s,a) of each state-action pair (s,a) is implemented by using a deep neural network.

Thus, rather than carrying out iterations to determine the optimal Q-function, a deep neural network is used which makes it possible to determine the Q-values of each state-action pair for a given environment. Concerning this aspect, those skilled in the art can refer to the document “Human-Level Control Through Deep Reinforcement Learning” Mnih, V., Kavukcuoglu, K., Silver, D. et al., Nature 518, 529-533, 2015.

A deep neural network is an artificial neural network comprising several hidden layers, and which accepts as input parameters {p₁, . . . , pₚ} of the state s(t). These layers determine the Q-values {Q(s, a₁), . . . , Q(s, aₐ)} for each action {a₁, . . . , aₐ} that can be carried out from this state s(t).

According to a third alternative, the reinforcement learning algorithm 101 is a policy gradient algorithm, and the determined function is a function which, for each state, determines a probability that an action is executed. Regarding this aspect, those skilled in the art can refer to the document “Reinforcement Learning, An introduction, Second Edition”, Richard S. Sutton and Andrew G. Barto, Sec. 13.1, The MIT Press, Cambridge, Massachusetts, 2018.

A policy gradient method is an iterative policy method that models and optimizes a policy π simultaneously. The policy π is updated to reach an optimal policy π* that maximizes a gain R(τ). At each iteration, this method draws experiments randomly, by meeting a probability provided by a policy, and thus prevents the agent from having knowledge of a model representative of the environment.

In this context, a trajectory T corresponds to a sequence of pairs {state s(t), actions a(t)} or triplets {state s(t), actions a(t), rewards r}, and the gain R(τ) corresponds to a sum of rewards r(t+1) between the current state s(t) and a final state s(T−1), and

$$R ( τ ) = {\sum }_{t = 0}^{T - 1} r ( t + 1 )$$

Conventionally, the policy π is modeled by an objective function J(π_{θ}) with π_{θ}(a|s) a parameterized policy, and θ policy parameters. Then,

$$J ( {π}_{θ} ) = {E}_{{π}_{θ}} [ {\sum }_{t = 0}^{T - 1} r ( t + 1 ) \vert {π}_{θ} ]$$

with E_{π}_{_{θ}} the mathematical expectation, and | the conditioning operator.

The objective function J(π_{θ}) makes it possible to maximize the value of the gain by adjusting the policy parameters θ, so as to determine an optimal policy. The algorithm of the gradient is an optimization algorithm that iteratively searches for the optimal parameters that maximize the objective function J(π_{θ}). The gradient ∇ of the objective function J(π_{θ}) is then expressed as follows:

$$∇ J ( {π}_{θ} ) = ∇ {E}_{{π}_{θ}} [ {\sum }_{t = 0}^{T - 1} r ( t + 1 ) \vert {π}_{θ} ]$$

$$∇ J ( {π}_{θ} ) = {E}_{{π}_{θ}} [ {\sum }_{t = 0}^{T - 1} {∇}_{θ} log {π}_{θ} ( a ( t ) \vert s ( t ) ) R ( τ ) ]$$

with ∇_{θ} the derivative with respect to θ of the function log π_{θ}

Thus, thanks to this learning method, a function which associates with each state a sequence of actions to be executed is determined.

REINFORCE is an example of a policy gradient method algorithm using the principle of Monte-Carlo sampling. Regarding this aspect, those skilled in the art can refer to the documents “Reinforcement Learning, An introduction, Second Edition”, Richard S. Sutton and Andrew G. Barto, Sec. 13.3 and 13.4, The MIT Press, Cambridge, Massachusetts, 2018 or “Simple statistical gradient-following algorithms for connectionist reinforcement learning”, Williams, R. J., Mach Learn 8, pp 229-256, 1992.

According to a fourth alternative, the reinforcement learning algorithm 101 is an Actor-Critic algorithm.

As mentioned above, the environment 200 comprises an anti-malware 201, for example conventional antivirus software or virus detection software using machine learning mechanisms. This anti-malware 201 is configured to analyze a file and, in return, calculate a detectability score p(t+1)⊂[0,1] representative of a probability that the file is considered malicious. The higher the score, the greater the probability that the analyzed file is malicious.

According to some embodiments, the environment 200 is configured to:
obtain actions a(t) aimed at modifying the content of a malware;
obtain a malware;
make modifications to the content of the malware obtained in accordance with said actions;
and, in response to an analysis of the anti-malware 201, return to the autonomous agent the detectability score and/or a reward representative of a probability that the malware modified by application of the selected action a(t) is considered benign by the anti-malware, or a state s(t+1) comprising said modified malware.

According to a first alternative, the anti-malware is virus detection software using machine learning mechanisms. The Ember models described in the document “EMBER: An Open Dataset for Training Static PE Malware Machine Learning Models”, H. Anderson & Al., ArXiv, 2018; Malconv describes in the document “Malware Detection by Eating a Whole EXE”, E. Raff & Al., ArXiv, 2017; and Grayscale describes in the document “Malware Analysis with Artificial Intelligence and a Particular Attention on Results Interpretability”, B. Marais & AL., ArXiv, 2021, are examples of anti-malwares using machine learning mechanisms.

These anti-malwares return a score p(t+1) where p(t+1) is a real number R from the set [0,1]. Based on this score p(t+1), the environment 200 determines a reward which is for example defined as follows:

$$r ( t ) = \{ \begin{matrix}R ⊂ {R}^{+} & if p ( t ) < T \\ p ( t ) - p ( t - 1 ) & otherwise\end{matrix}$$

with R a real positive value, and T a threshold value specific to the virus detection software using machine learning mechanisms.

Thus, when Ember is used, T takes for example the value 0.8336, and when Malconv or Grayscale are used, T takes for example the value 0.5.

According to a second alternative, the anti-malware is a conventional virus detection software, such as McAfee (registered trademark), which returns a score p(t+1) equal to 0 or 1. Based on this binary score, the environment 200 determines a reward which is for example defined as follows:

$$r ( t ) = \{ \begin{matrix}R ⊂ {R}^{+} & if p ( t + 1 ) = 0 \\ 0 & otherwise\end{matrix}$$

FIG. 2 schematically represents one particular embodiment of an autonomous agent 100 as proposed.

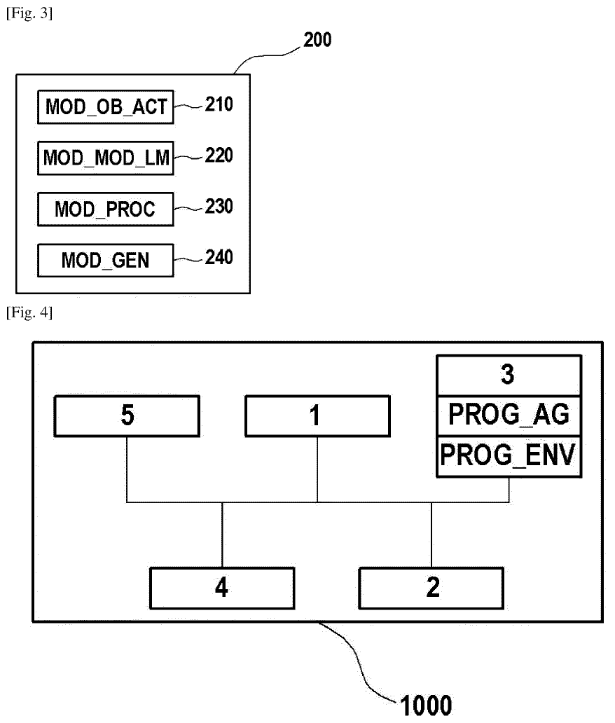

FIG. 3 schematically represents one particular embodiment of an environment 200 as proposed.

FIG. 4 schematically represents one example of hardware architecture of a reinforcement learning system of FIG. 1.

As illustrated in FIG. 4, the reinforcement learning system has the hardware architecture of a computer. Thus, the system includes, in particular, a processor 1, a random access memory 2, a read-only memory 3 and a non-volatile memory 4. It further includes a communication module 5.

The read-only memory 3 of the system constitutes a recording medium as proposed, readable by the processor 1 and on which a computer program PROG_AG in accordance with the invention is recorded, including instructions for the execution of steps of the training method as proposed. The program PROG_AG defines functional modules of the agent 100 as represented in FIG. 2, which rely on or control the hardware elements 1 to 5 of the system mentioned above, and which comprise in particular:
a module 110 for selecting an action (a(t)) aimed at modifying the content of a malware;
a module 120 for obtaining a reward (r(t+1)) representative of a probability that the malware modified by application of the selected action (a(t)) is considered benign by an anti-malware;
a module 130 for obtaining a state (s(t+1)) representative of the malware modified by application of the selected action (a(t)); and,
a module 140 for determining a function which associates with each state at least one action to be executed, so as to maximize a sum of obtained rewards.

It should be noted that the module 140 for determining a function is for example a module of the reinforcement learning algorithm responsible for “learning”.

Moreover, the agent can further include other modules, in particular to implement particular modes of the determination method and as described in more detail later.

A computer program PROG_ENV as proposed, including instructions for the execution of steps of the evaluation method as proposed is also recorded on the read-only memory 3 of the system. The program PROG_ENV defines functional modules of the environment 200 as represented in FIG. 3, which rely on or control the hardware elements 1 to 5 of the system mentioned above, and which comprise in particular:
a module 210 for obtaining an action (a(t)) aimed at modifying the content of a malware;
a module 220 for modifying the content of a malware in accordance with said action (a(t)), so as to obtain a modified malware;
a module 230 for analyzing, by the anti-malware, the modified malware; and
a module 240 for generating either a reward (r(t+1)) representative of a probability that the malware modified by application of the selected action (a(t)) is considered benign by the anti-malware, or a detectability score (p(t+1)) representative of a probability that the malware modified by application of the selected action (a(t)) is considered malicious by the anti-malware.

The communication module 5 in particular allows the environment 200 to communicate, via a communication network, with the malware database 300, to obtain a malware on which an action must be carried out. To do so, the communication module 5 includes a wired or non-wired communication interface able to implement any protocol supported by the communication network. In this way, once in possession of said malware, the environment 200 is able to implement the evaluation method as proposed.

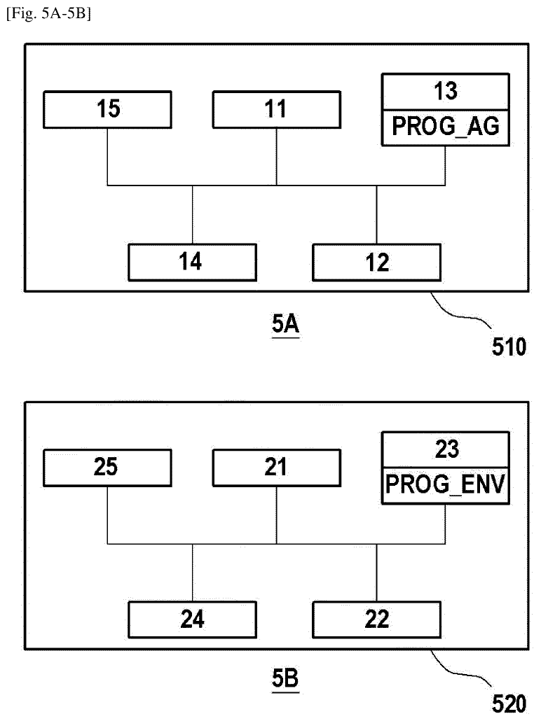

FIGS. 5A and 5B comprises FIG. 5a which schematically represents one example of hardware architecture of a device 510 implementing an autonomous agent 100 belonging to a reinforcement learning system of FIG. 1, and FIG. 5b which schematically represents one example of hardware architecture of a device 520 implementing an environment 200 belonging to the reinforcement learning system of FIG. 1.

As illustrated in FIG. 5a, the device 510 has the hardware architecture of a computer. Thus, the device 510 includes, in particular, a processor 11, a random access memory 12, a read-only memory 13 and a non-volatile memory 14. It further includes a communication module 15. The read-only memory 13 of the device constitutes a recording medium in accordance with the invention, readable by the processor 11 and on which the computer program PROG_AG previously described is recorded.

The communication module 15 in particular allows the device 510 to communicate, via a communication network, with the device 520, to transmit to it an action a(t) to be carried out by the environment and aimed at modifying the content of a malware, but also to receive a reward (r(t+1)) and/or a detectability score (p(t+1)) from the environment.

As illustrated in FIG. 5b, the device 520 also has the hardware architecture of a computer. Thus, the device 520 includes, in particular, a processor 21, a random access memory 22, a read-only memory 23 and a non-volatile memory 24. It further includes a communication module 25. The read-only memory 23 of the device constitutes a recording medium in accordance with the invention, readable by the processor 21 and on which the computer program PROG_ENV previously described is recorded.

The communication module 25 in particular allows the device 520 to communicate, via a communication network, with the device 510, to receive from said device 510 an action a(t) aimed at modifying the content of a malware, but also to transmit a reward (r(t+1)) and/or a detectability score (p(t+1)) to said device 510.

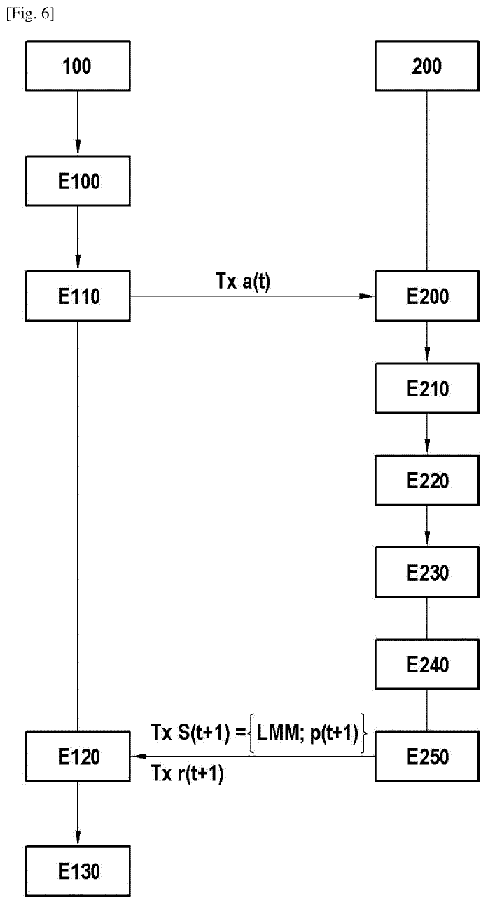

FIG. 6 represents, in flowchart form, one particular mode of implementation of a general reinforcement learning method as proposed and as it is implemented by the autonomous agent of FIG. 2 and the environment of FIG. 3. This general learning method comprises a training method composed of steps E100 to E120 and implemented by the autonomous agent 100, as well as an evaluation method composed of steps E200 to E250 and implemented by the environment 200.

As illustrated by FIG. 6, the general learning method comprises a first step E100 implemented by the autonomous agent 100. For a certain current state s(t), an action a(t) to be carried out is selected from a set of at least one action (but possibly comprising a plurality of actions) that can be carried out for this state s(t). Said step E100 is implemented by the selection module 110 equipping the autonomous agent 100.

If the autonomous agent 100 has no knowledge of the environment, said agent 100 explores its environment by testing a plurality of actions for a plurality of states, in order to learn the most favorable possibilities, and thus determine the policy that maximizes a sum of received rewards. On the other hand, to maximize the sum of received rewards, the agent must also exploit the acquired knowledge.

Consequently, according to some embodiments, to obtain a balance between the exploitation and the exploration, a strategy called “Epsilon Greedy” strategy is implemented to select the action to be carried out.

The actions that can be carried out aim to modify the content of a malware, but must not impact the malicious functionalities of said malware. Thus, if the malware has, for example as malicious functionalities, the encryption of the memory of a first equipment and the deletion of the content from this memory after a predetermined duration, the modification of the content of said malware must not have an impact on these two malicious functionalities.

Examples of actions that aim to modify the content of a malware include:
modifying the value of the field of a header of the malware. Particularly, when the file format of the malware is of the “portable executable” (PE) type, the modification of the value of the header field can correspond to the modification of a value of the “Machine Type” field of the COFF header.
adding a sequence of characters extracted from a benign file to the content of the malware. Some anti-malwares consider that a file can be considered as having a benign behavior when it comprises some character sequences commonly used in benign files. These character sequences can be determined during prior processing, by statistical analysis of benign file contents.
adding determined characters or instructions to the content of the malware. This is sometimes referred to as “padding”. For example, this could involve the addition of a sequence of zeros or the addition of an instruction telling the processor to do nothing when it needs to process this instruction.
adding a library extracted from a benign file to the content of the malware. Some anti-malwares consider that a file can be considered as having a benign behavior when it comprises some libraries commonly used in benign files. These libraries can be determined during a prior processing, by statistical analysis of benign file contents.
renaming a section of the content of the malware. When the malware file format is of the “portable executable” type, said malware comprises sections of the binary that must be loaded into memory, for example “.text”, “.bss”, “.data”, “.upx”. This action aims to rename these sections.
removing a debugger mode from the content of the malware. The malwares sometimes use a debugger mode to analyze a computer program, in order to reverse engineer it and thus determine flaws or design exploits. Since some anti-malwares use debugger detection codes, the removal of such a mode advantageously makes it more difficult to detect a malware.
modifying a timestamp of the content of the malware;
modifying a hash value calculated for an optional header of the content of the malware; and,
decompressing an executable version of the malware. Some anti-malwares qualify an executable file as malicious as soon as it is encrypted. This is why the decompression advantageously makes it more difficult to detect a malware.

The selected action a(t) is transmitted to the environment 200 during a step E110, which receives this action during a step E200. During a step E210, the environment 200 obtains a malware, for example by accessing a database 300 of malwares. Said step E210 is implemented by the module for obtaining 210 an action equipping the environment 200.

During a step E220, the environment 200 modifies the content of the malware in accordance with the action received during step E200. Said step E220 is implemented by the module 220 for modifying a content equipping the environment 200. According to some embodiments, the environment 200 performs a syntactic analysis of the content of the malware, and determines part of the content whose modification does not impact any malicious functionality of the malware. In this case, step E220 comprises the modification of said part.

Then during a step E230, the modified malware is analyzed by an anti-malware from the environment 200 which generates a detectability score p(t+1) representative of a probability that the malware modified by application of the selected action a(t) is considered malicious by the anti-malware. The higher the score, the greater the probability that the analyzed file is malicious. Said step E230 is implemented by the analysis module 230 equipping the environment 200.

During a step E240, the environment determines a reward representative of a probability that the malware modified by application of the selected action a(t) is considered benign by the anti-malware. As mentioned above, this reward is calculated as a function of the value of the score generated during step E230. Said step E240 is implemented by the generation module 240 equipping the environment 200.

During a step E250, the environment transmits the reward r(t+1) determined during step E240, as well as a state s(t+1) comprising the malware modified in accordance with the action a(t), the state further comprising the value of the detectability score p(t+1) determined during step E230.

This information is received by the autonomous agent 100 during a step E120, and allows it to determine, during a step E130, a function which associates with each state an action or a sequence of actions to be executed, so as to maximize a sum of the obtained rewards. Said step E130 is implemented by the determination module 140 equipping the agent 100.

As described above, when the reinforcement learning algorithm implemented by the autonomous agent 100 is a “Q-learning” algorithm, for a current state s(t), the determination comprises the update of a Q-value for the state s(t)-actions a(t) pairs which depends on the reward value r(t+1) received at the current iteration. And when the reinforcement learning algorithm implemented by the autonomous agent 100 is a policy gradient algorithm, the determination comprises the update of a probability that an action a(t) is relevant to make the detection of a malware more complex, given the current state s(t).

The steps of selecting an action, obtaining a reward and obtaining a state are iterated as long as a stopping criterion is not reached. The evaluation of this criterion is carried out by an evaluation module (not represented) equipping the agent 100, for example after the determination or the update of the function which associates with each state an action or a sequence of actions to be executed. Thus and according to a first example, the stopping criterion consists in comparing a sum of rewards received with a determined value. According to a second example, the stopping criterion consists in comparing the index of the current iteration with a maximum number of iterations.

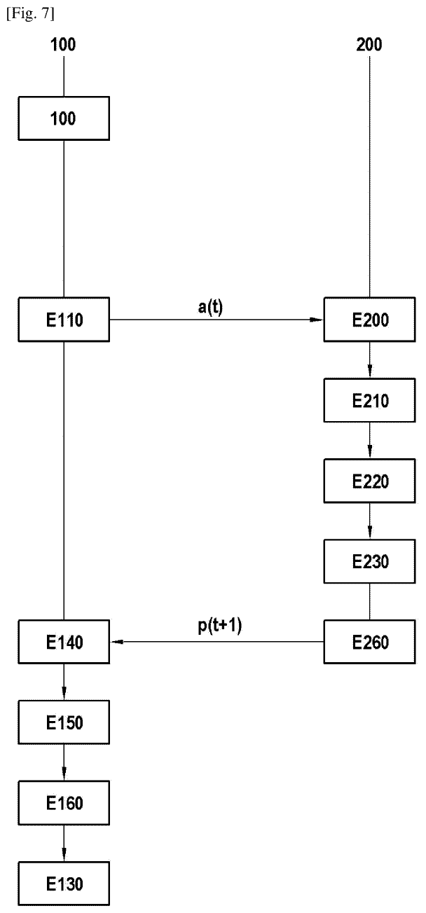

FIG. 7 represents, in flowchart form, one particular mode of implementation of a general reinforcement learning method as proposed and as it is implemented by the autonomous agent of FIG. 2 and the environment of FIG. 3. This general learning method comprises a training method composed of steps E100, E110, E140, E150, E160, E130 and implemented by the autonomous agent 100, as well as an evaluation method composed of steps E200, E210, E220, E230, E260 and implemented by the environment 200.

FIG. 7 is a variant of the embodiment illustrated in FIG. 6. The elements common to these two distinct embodiments bear the same numeral references and have identical characteristics so that they are not described again for the sake of simplicity.

As illustrated in FIG. 7, the general learning method comprises a first step E100 of selecting an action a(t) from a set of at least one action, implemented by the autonomous agent 100.

The selected action a(t) is transmitted to the environment 200 during a step E110, which receives this action during a step E200. During a step E210, the environment 200 obtains a malware, for example by accessing a malware database 300.

Then during a step E220, the environment 200 modifies the content of the malware in accordance with the action received during step E200. During a step E230, the modified malware is analyzed by an anti-malware from the environment 200 which generates a detectability score p(t+1) representative of a probability that the malware modified by application of the selected action a(t) is considered malicious by the anti-malware.

During a step E260, the environment transmits to the autonomous agent 100 the score p(t+1) determined during step E230, which is received during a step E140.

Then during a step E150, the autonomous agent 100 determines a state corresponding to a malware whose content has been modified by application of an action a(t). To do so, the agent 100 obtains the malware before it is modified, for example by accessing a malware database 300, and determines a modified version by application of the action it selected during step E100.

During a step E160, the autonomous agent 100 determines a reward r(t+1) based on the score p(t+1) received during step E140. Finally, during a step E130, a function which associates with each state an action to be executed is determined, so as to maximize a sum of the obtained rewards.

In some embodiments, the general learning method as proposed further comprises the generation of an association between the action (a(t)), and either the score (p(t+1)), or the reward (r(t+1)) in an association table. This association table can then be transmitted to the anti-malware software authors. This information turns out to be crucial for them since it allows them to improve the performance of their solutions in terms of malware detection.

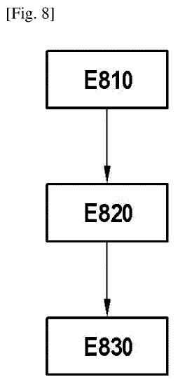

FIG. 8 represents, in flowchart form, one particular mode of implementation of an anti-malware training method implementing a learning algorithm.

As illustrated in FIG. 8, the anti-malware training method comprises a first step E810 of obtaining a plurality of modified malwares, each malware from the plurality having a score representative of a probability that the modified malware will be considered malicious by the anti-malware, the score of each malware from the plurality being less than a defined value.

The plurality of modified malwares is for example obtained by accessing a database linked to the database 300, or corresponding to said database 300.

At each iteration of the general reinforcement learning method of FIG. 6 or FIG. 7, it is for example determined whether the detectability score p(t+1) of the modified malware is less than a defined value (e.g., 0.45) characterizing the fact that this modified malware, before relearning (that is to say before the implementation of steps E810 to E830), is not considered as having a malicious behavior by the anti-malware. If this is the case, the modified malware and this detectability score p(t+1) are recorded in said database 310. As a variant, the malware obtained during step E210 of the general method, the action a(t) selected during step E100 and the detectability score p(t+1) are recorded in said database 310. Said step E810 is implemented by an obtaining module equipping the environment 200.

Then during a step E820, the malwares from the plurality are labeled as having a malicious behavior. Said step E810 is for example implemented by a labeling module equipping the environment 200.

These data (e.g., the modified malwares and their labels) are used during a training step E830 by the anti-malware learning algorithm. Said step E830 is implemented by a training module linked to the anti-malware learning algorithm. This step allows it to improve its knowledge, so as to enable it to detect malwares (e.g., to determine after analysis that these software have malicious behavior), even if actions have been carried out on the content of said malware aimed at making it undetectable.

The invention has been described so far in the case where a sum of obtained rewards is maximized, but the invention nonetheless remains applicable in the particular case where the stopping criterion is reached at the end of a single iteration, and the sum then corresponds to a single obtained reward.

Although the present disclosure has been described with reference to one or more examples, workers skilled in the art will recognize that changes may be made in form and detail without departing from the scope of the disclosure and/or the appended claims.

1. A training method for training an autonomous agent implementing a reinforcement learning algorithm to improve performance of anti-malware software, the method being implemented by the autonomous agent and comprising:
selecting an action aimed at modifying the content of a malware;
transmitting the selected action to an environment implementing said anti-malware software;
receiving, from the environment, a reward representative of a probability that the malware modified by application of the selected action is considered benign by the anti-malware software, the reward being defined as:
$$r ( t + 1 ) = \{ \begin{matrix}R ⊂ {R}^{+} & if p ( t + 1 ) < T \\ p ( t + 1 ) - p ( t ) & otherwise\end{matrix}$$
with R a positive real value, T a threshold value specific to the anti-malware software, p(t+1) a detectability score representative of a probability that the malware modified by application of the selected action is considered malicious by the anti-malware software, and p(t) the detectability score by application of an action selected in a previous iteration;
obtaining a state representative of the malware modified by application of the selected action;
wherein selecting an action, receiving a reward and obtaining a state are iterated as long as a stopping criterion is not reached; and,
determining, by the reinforcement learning algorithm and based on the obtained rewards, a function which associates with each state at least one action to be executed, so as to maximize a sum of the obtained rewards.

2. The training method according to claim 1, wherein obtaining a state comprises either receiving the state from the environment; or obtaining the malware on which an action can be applied, and determining the state based on the selected action and on the obtained malware.

3. The training method according to claim 1, wherein the reinforcement learning algorithm is a “Q-learning” algorithm, and the determination of the function comprises a determination, for each state-action pair (s,a), of a value Q^{N}(s,a) such that:
$${Q}^{N} ( s , a ) = ( 1 - α ) Q ( s , a ) + α ( r ( t + 1 ) + γ {max}_{a ( t + 1 )} Q ( s ( t + 1 ) , a ( t + 1 ) ) )$$
with α⊂[0,1] a learning rate, Q(s,a) a previous quality value, r(t+1) a reward, γ⊂[0,1] a refresh rate, s(t+1) a next state and a(t+1) an action that can be executed from the state s(t+1), so as to determine an optimal Q-function.

4. The training method according to claim 1, wherein the action is selected from a set of actions consisting of:
modifying a value of a field of a header of the malware;
adding to the content of the malware a sequence of characters extracted from a benign file;
adding to the content of the malware determined characters or instructions;
adding to the content of the malware a library extracted from a benign file;
renaming a section of the content of the malware;
removing a debugger mode from the content of the malware;
modifying a timestamp of the content of the malware;
modifying a hash value calculated for an optional header of the content of the malware; and,
decompressing an executable version of the malware.

5. (canceled)

6. A non-transitory computer-readable recording medium on which a computer program is recorded comprising instructions which when executed by a processor of an autonomous agent configure the autonomous agent to implement a method for training an autonomous agent implementing a reinforcement learning algorithm to improve the performance of anti-malware software, the method comprising:
selecting an action aimed at modifying the content of a malware;
transmitting the selected action to an environment implementing said anti-malware software;
receiving, from the environment, a reward representative of a probability that the malware modified by application of the selected action is considered benign by the anti-malware software, the reward being defined as:
$$r ( t + 1 ) = \{ \begin{matrix}R ⊂ {R}^{+} & if p ( t + 1 ) < T \\ p ( t + 1 ) - p ( t ) & otherwise\end{matrix}$$
with R a positive real value, T a threshold value specific to the anti-malware software, p(t+1) a detectability score representative of a probability that the malware modified by application of the selected action is considered malicious by the anti-malware software, and p(t) the detectability score by application of an action selected in a previous iteration;
obtaining a state representative of the malware modified by application of the selected action;
wherein selecting an action, receiving a reward and obtaining a state are iterated as long as a stopping criterion is not reached; and,
determining, by the reinforcement learning algorithm and based on the obtained rewards, a function which associates with each state at least one action to be executed, so as to maximize a sum of the obtained rewards.

7. An evaluation method for evaluating detectability of a malware by an environment implementing at least one anti-malware software, the method comprising:
receiving, from an autonomous agent implementing a reinforcement learning algorithm, an action aimed at modifying content of the malware;
modifying the content of the malware by application of said action, so as to obtain a modified malware;
analyzing, by the anti-malware software, the modified malware;
and transmitting, to the autonomous agent, a reward representative of a probability that the malware modified by application of the selected action (a(t)) is considered benign by the anti-malware software, the reward being defined as:
$$r ( t + 1 ) = \{ \begin{matrix}R ⊂ {R}^{+} & if p ( t + 1 ) < T \\ p ( t + 1 ) - p ( t ) & otherwise\end{matrix}$$
with R a positive real value, T a threshold value specific to the anti-malware software, p(t+1) a detectability score representative of a probability that the malware modified by application of the selected action is considered malicious by the anti-malware software, and p(t) the detectability score by application of an action selected in a previous iteration.

8. The evaluation method according to claim 7, further comprising generating an association between the action, and either the score p(t+1), or the reward r(t+1) in an association table.

9. (canceled)

10. A non-transitory computer-readable recording medium on which a computer program is recorded comprising instructions which when executed by a processor of an environment configure the environment to implement a method for evaluating detectability of a malware by an environment implementing at least one anti-malware software, the method comprising:
receiving, from an autonomous agent implementing a reinforcement learning algorithm, an action aimed at modifying the content of the malware;
modifying the content of the malware by application of said action, so as to obtain a modified malware;
analyzing, by the anti-malware software, the modified malware;
and transmitting, to the autonomous agent, a reward representative of a probability that the malware modified by application of the selected action (a(t)) is considered benign by the anti-malware software, the reward being defined as:
$$r ( t + 1 ) = \{ \begin{matrix}R ⊂ {R}^{+} & if p ( t + 1 ) < T \\ p ( t + 1 ) - p ( t ) & otherwise\end{matrix}$$
with R a positive real value, T a threshold value specific to the anti-malware software, p(t+1) a detectability score representative of a probability that the malware modified by application of the selected action is considered malicious by the anti-malware software, and p(t) the detectability score by application of an action selected in a previous iteration.

11. A method for training anti-malware software implementing a learning algorithm, the method comprising:
obtaining a plurality of modified malwares in accordance with a method for evaluating detectability of a malware by an environment implementing at least one anti-malware software according to claim 7, each malware of the plurality having a detectability score (p(t+1)) representative of a probability that the modified malware is considered malicious by the anti-malware software, the score of each malware from the plurality being less than a defined value;
labeling said malwares as malicious; and,
training the anti-malware software with the labeled malwares.

12. (canceled)

13. A non-transitory computer-readable recording medium on which a computer program is recorded comprising instructions which when executed by a processor of an electronic device configure the electronic device to implement a training method comprising:
obtaining a plurality of modified malwares in accordance with a method for evaluating detectability of a malware by an environment implementing at least one anti-malware software according to claim 7, each malware of the plurality having a detectability score (p(t+1)) representative of a probability that the modified malware is considered malicious by the anti-malware software, the score of each malware from the plurality being less than a defined value;
labeling said malwares as malicious; and,
training the anti-malware software with the labeled malwares.

14. An autonomous agent implementing a reinforcement learning algorithm to improve performance of anti-malware software, the agent comprising:
at least one processor; and
at least one non-transitory computer readable medium comprising instructions stored thereon which when executed by the at least one processor configure the agent to implement a method for training, comprising:
selecting an action aimed at modifying content of a malware;
transmitting the selected action to an environment implementing said anti-malware software;
receiving, from the environment, a reward representative of a probability that the malware modified by application of the selected action (a(t)) is considered benign by the anti-malware software, the reward being defined as:
$$r ( t + 1 ) = \{ \begin{matrix}R ⊂ {R}^{+} & if p ( t + 1 ) < T \\ p ( t + 1 ) - p ( t ) & otherwise\end{matrix}$$
with R a positive real value, T a threshold value specific to the anti-malware software, p(t+1) a detectability score representative of a probability that the malware modified by application of the selected action is considered malicious by the anti-malware software, and p(t) the detectability score by application of an action selected in a previous iteration;
obtaining a state representative of the malware modified by application of the selected action;
wherein selecting an action, receiving a reward and obtaining a state are iterated as long as a stopping criterion is not reached; and,
determining, by the reinforcement learning algorithm and based on the obtained rewards, a function which associates with each state at least one action to be executed, so as to maximize a sum of the obtained rewards.

15. An environment for evaluating detectability of a malware by anti-malware software, the environment comprising:
at least one processor; and
at least one non-transitory computer readable medium comprising instructions stored thereon which when executed by the at least one processor configure the environment to implement, the method comprising:
receiving, from an autonomous agent implementing a reinforcement learning algorithm, an action aimed at modifying content of the malware;
modifying the content of the malware by application of said action, so as to obtain a modified malware;
analyzing, by the anti-malware software, the modified malware;
and transmitting, to the autonomous agent, a reward representative of a probability that the malware modified by application of the selected action (a(t)) is considered benign by the anti-malware software, the reward being defined as:
$$r ( t + 1 ) = \{ \begin{matrix}R ⊂ {R}^{+} & if p ( t + 1 ) < T \\ p ( t + 1 ) - p ( t ) & otherwise\end{matrix}$$
with R a positive real value, T a threshold value specific to the anti-malware software, p(t+1) a detectability score representative of a probability that the malware modified by application of the selected action is considered malicious by the anti-malware software, and p(t) the detectability score by application of an action selected in a previous iteration.
